(19) United States
(12) Patent Application Publication
(10) Pub. No.: US 2019/0279247 A1
(43) Pub. Date: Sep. 12, 2019

(54) CROWD-SOURCED MAPPING

(71) Applicant: HERE Global B.V., Eindhoven (NL)

(72) Inventors: Joshua Michael Finken, Park City, UT (US); Stephen O'Hara, Fort Collins, CO (US)

(21) Appl. No.: 15/915,880

(22) Filed: Mar. 8, 2018

(51) Int. Cl. G06Q 30/02; G06F 17/30; G06F 21/60; H04L 9/06; G06Q 20/36; G06Q 20/06

(52) U.S. Cl. CPC G06Q 30/0236; G06F 17/30241; G06F 21/602; G06F 17/3087; G06Q 2220/00; G06Q 30/0215; G06Q 20/36; G06Q 20/065; H04L 9/0637

(57) ABSTRACT

Systems and methods are provided to incentivize collection of high definition (HD) map content. The system includes at least one sensor, a communications interface, and a device processor. The sensor is configured to acquire sensor data relating to a feature at a location on a roadway. The communications interface is configured to communicate with at least one other device. The device processor is configured to generate an observation data package from the sensor data, perform, using the location, a spatial query on a blockchain configured to store a plurality of data entries to identify whether any data entries of the plurality of data entries exist for the observation data package. When no data entries exist, the device processor is configured to generate a new data entry for the blockchain for the observation data package, and when a data entry exists, validate the observation data package and augment the existing data entry.

### FIELD

The following disclosure relates to navigation and/or mapping services.

### BACKGROUND

Modern vehicles require accurate navigational systems. A vehicle may eliminate many dangerous unknowns by identifying exactly where the vehicle is on the road in real time, along with its immediate surroundings. A high definition (HD) map may be a crucial component of assisted or automatic driving technology. Vehicles may include many sensors, but an HD map may be the most important tool vehicles use.

An HD map may be needed not only to allow a vehicle to precisely position itself laterally and longitudinally, but to enable the car to maneuver correctly. While sensors in vehicles may detect out around 100 meters, a car traveling at 80 miles per hour may only have a sensing horizon of 3 seconds. Vehicles need highly accurate and up to date maps to extend sensor range and “peek” around the corner.

Sensors in vehicles may be able to detect lanes and lane markings in real time using image processing and light detection and ranging (LIDAR) based systems. These systems are useful for obstacle avoidance and detecting the movements of other vehicles. When used alone though, on-board sensor systems may exhibit large blind spots and may be unable to predict events or maneuvers even a short distance away.

On-board sensors, however, when combined with HD maps may allow for assisted and highly automated vehicle operation. HD maps may allow a vehicle to identify precisely where it is with respect to the road (or the world) far beyond what the Global Positioning System (GPS) can do, and without inherent GPS errors. The HD map allows the vehicle to plan precisely where the vehicle may go, and to accurately execute the plan because the vehicle is following the map. By identifying precisely where a vehicle is on the road to the decimeter or even centimeter, and understanding the surroundings, a mapping platform may bring advanced safety to an ever-changing environment.

An HD map must be updated at regular intervals to reflect changes to the roadway network. Permanent, semi-permanent, and temporary objects such as signage, lane changes, new roadways, and other features may be regularly added or removed from the roadway. To maintain an updated HD map, each of these features needs to be observed, recorded, and validated. Manual observation may be used to identify new features but is not scalable for an entirely of the roadway network. Automated observations taken from dedicated probe vehicles may also be used to collect observation data. A dedicated fleet of probe vehicles, however, may be expensive to operate and may not be able to adequately cover the entirety of the roadway.

### SUMMARY

In an embodiment, a system is provided for incentivizing collection of map data comprising a plurality of devices for collecting map data. Each of the plurality of devices includes at least one sensor, a communications interface, and a device processor. The at least one sensor is configured to acquire sensor data relating to a feature at a location on a roadway. The communication interface is configured to communicate with at least one other device of the plurality of devices. The device processor is configured to generate an observation data package from the sensor data, perform, using the location, a spatial query on a blockchain configured to store a plurality of data entries to identify whether any data entries of the plurality of data entries exist for the observation data package. When no data entries exist, the device processor is configured to generate a new data entry for the blockchain for the observation data package. When a data entry exists, the device processor is configured to validate the observation data package and augment the existing data entry.

In an embodiment, a method is provided for incentivizing collection of map data by a navigation device. The navigation device collects observation data for a new feature on a roadway. The navigation device generates an observation data package based on the observation data. The navigation device queries a blockchain network for a data entry related to the feature data. The navigation device generates a data entry when no existing data entry is found on the blockchain network, or validating, when found on the blockchain, by the navigation device, the existing data entry and augmenting the existing data entry with an address for the navigation device. The navigation device transmits the new data entries or the augmented existing data entry to a plurality of nodes of the blockchain network to be added to a block of the blockchain network.

In an embodiment, a method is provided for incentivizing collection of map data. A location is traversed by a navigation device. The navigation device queries a blockchain by location for a smart contract relating to the observation data package in the blockchain. The navigation device accesses the observation data package. The navigation device augments the smart contract with a wallet address of the navigation device. The navigation device transmits the augmented smart contract to a plurality of nodes of the blockchain for verification and addition to the blockchain. When the augmented smart contract is added to the blockchain, an amount of digital currency is transferred from the wallet address of the navigation device to one or more wallet addresses listed in the augmented smart contract.

### BRIEF DESCRIPTION OF THE DRAWINGS

Exemplary embodiments of the present invention are described herein with reference to the following figures.

FIG. 1 depicts an example high definition map.

FIG. 2 depicts a system for incentivizing collection of high definition map content according to an embodiment.

FIG. 3 depicts an example map of a geographic region.

FIG. 4 depicts an example data structure of a geographic database.

FIG. 5 depicts a workflow for incentivizing and validating collected map data according to an embodiment.

FIG. 6 depicts an example blockchain.

FIG. 7 depicts an example of contract generation according to an embodiment.

FIG. 8 depicts an example of contract validation according to an embodiment.

FIG. 9 depicts an example of contract consumption according to an embodiment.

FIG. 10 depicts an example workflow for incentivizing and validating collected map data according to an embodiment.

FIG. 11 depicts an example device of the system of FIG. 2.

### DETAILED DESCRIPTION

Embodiments described herein provide systems and methods to incentivize vehicles and/or device owners to collect high definition (HD) map content to enlarge the number of crowd-sourcing HD map content creators and participants while simultaneously driving down the overall cost of sourcing the crowd-sourced data. Embodiments provide incentivized map creation and validation through a cryptocurrency-based marketplace and a decentralized consensus network.

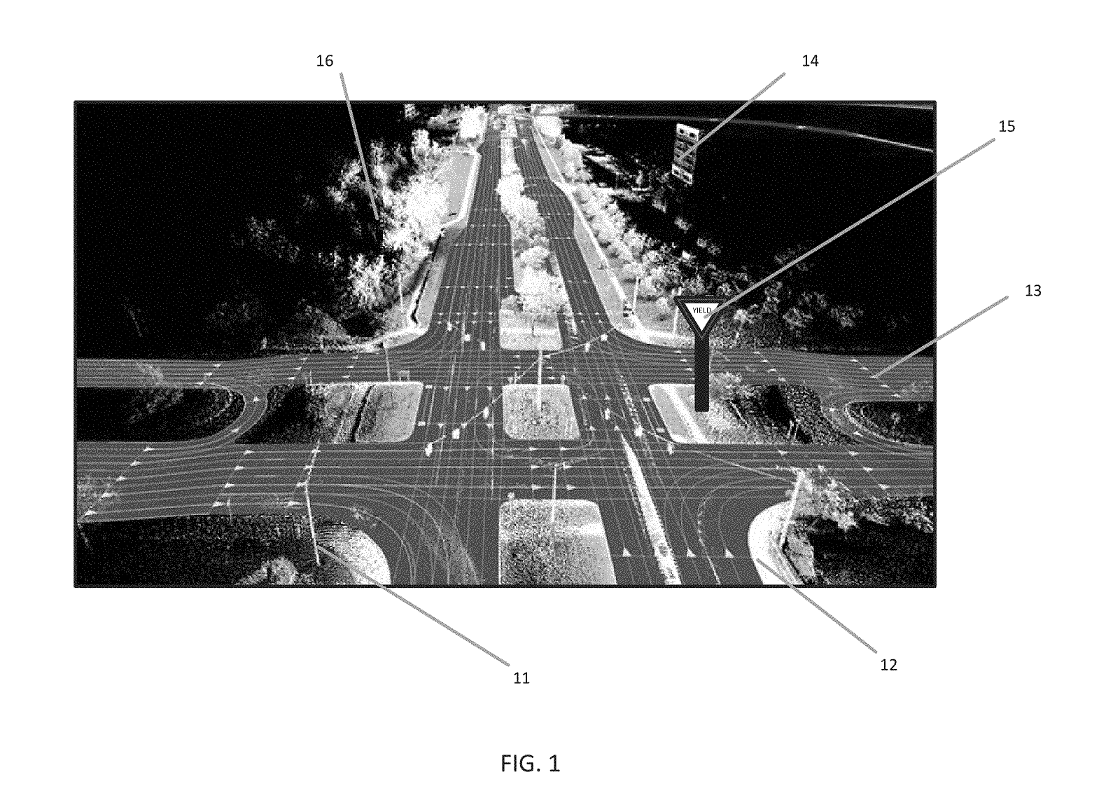

FIG. 1 illustrates an example rendered view of an HD map. FIG. 1 depicts a section of roadway including multiple features. For example, FIG. 1 depicts poles 11, sidewalks 12, trees 16, signs 14, curbs, medians, the road surface, etc. Overlaid on FIG. 1 is a plurality of paths 13 for a vehicle to take. Each of the features and paths in the HD map may provide guidance to a user or vehicle that traverses the section of the roadway. The HD map, however, is not perfect. New features or changes to the roadway may be implemented regularly. For example, the yield sign 15 as depicted is not part of the HD map. However, sensors on a vehicle may identify a new object when traversing the roadway. A navigation device may attempt to identify what the object is. In this example, the navigation device may determine that the object is a yield sign 15. Based on the determination, the navigation device may present a user the information or generate a command regarding operation of the vehicle. Real time determination of features is not ideal. Vehicles have a short amount of time from when a feature is detected by sensors and when a decision needs to be made for operation of the vehicle. In addition, a vehicle may already be processing a full load of sensor data relating to other transitory objects on the roadway such as other vehicles, bicycles, pedestrians etc. Requiring each vehicle to make the determination may also be inefficient. Ideally, features on a roadway may be identified and added to the HD map so that other navigation devices are able to conserve resources and operate efficiently.

A navigation device may be integrated into an autonomous vehicle, a highly automated driving (HAD) vehicle, and/or an advanced driving assistance systems (ADAS) vehicle. The navigation device may be configured as a navigation system for an autonomous vehicle or a HAD vehicle. An autonomous vehicle or HAD vehicle may take route instruction or operational instructions based on the information provided to the navigation device. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. Autonomous vehicles may park themselves or move cargo between locations without a human operator. Autonomous vehicles may include multiple modes and transition between the modes. The autonomous vehicle may steer, brake, or accelerate the vehicle based on the position of the vehicle based on a determination from the navigation device.

For safe operation of the vehicle, autonomous vehicles require reliable map information to assist the vehicles in any situation, such as knowing road layouts, what obstructions may lie ahead, and updates about local traffic laws. Data from a HD map is a primary source of guidance for autonomous vehicles. However, the roadway is not static. The roadway, objects, and features there within are constantly shifting and evolving, and as such, a HD map that supports autonomous driving must constantly detect, verify, and update the changes that happen in the world to the map in near real-time. One method for a map to obtain the level of updates is to crowdsource data from the sensors of vehicles on the roadway to identify changes and adapt to match the environment. With a map that is continuously updated, vehicles are provided with an awareness of the road environment far beyond the reach of just the vehicle sensors. With the ability to know what's further ahead, vehicles may anticipate scenarios and make the necessary adjustments.

Generating and maintaining an updated HD map requires constant collection and validation of HD map content from a large number of content collectors. Such as system may incentivize users and/or vehicles to collect data for cloud-based map creation via traditional central banking mechanisms, a simple point-based system, gift card redemption, or possibly no explicit encouragement or motivation at all. One method incentivizes collection though points. Vehicles traverse the roadway, record observations, and report the observations to a central observation bank. In return, the central observation bank “pays” the vehicles using a point-based system. The points may be redeemable for cash equivalents or may just be purely a scoring system for a non-monetary competition.

Other methods mandate collection by a fleet of vehicles. For example, a manufacturer may obligate vehicles in their fleet to collect data. An OEM vehicle manufacturer may require data collection contractually from users. Similarly, certain mapping applications may automatically collect data without compensation from application users. Each of these methods may have drawbacks. In the scenario where a central observation bank collects data, the centralization and non-transparent process may be limiting. In an example, $0.01 to $0.05 per mile is paid in fiat currency via a bank or gift cards. One of the biggest issues is the introduction of multiple central authorities: a financial portal as the payment system and the underlying banks that provide the final transaction resolution. Each layer charges one or more fees while exhibiting a lack of transparency with respect to those fees, the transactions themselves and the security of those transactions. Furthermore, due to the proprietary and closed system, the central observation bank potentially offers a threat to the autonomous ambitions of other companies. The central observation bank may cut off or penalize competition or likewise be targeted by the competition leading to a fractured and duplicative collection scheme. Additionally, there is no loyalty mechanism in these approaches. None of the methods provide an incentive to remain loyal to the collection program and to continue to participate in the platform.

In an embodiment, systems and methods are provided for incentivizing map data collection and validation using a decentralized database and a digital currency. Smart contracts stored on a blockchain are used to provide a transparent mechanism to reward vehicles or users to collect and validate map data. Blockchain technology allows for a distributed or decentralized database or ledger. Blockchain technology also allows for distributed computing processes, for example, verifying pieces of data.

In an example embodiment, a new yield sign is added to the physical roadway. A vehicle is traversing the roadway near the yield sign. As the yield sign is new, an HD map that a navigation device in the vehicle is using does not include data for the yield sign. However, as the vehicle approaches the yield sign, sensors on the vehicle identify that there is a new feature on the roadway. Using the sensor data, the navigation device determines that the feature is a new yield sign and identifies the state of the vehicle and the location of the new yield sign. The navigation device queries a blockchain (referred to herein as a MapCoin blockchain) for an entry that relates to the new yield sign. Finding no entry, the navigation device generates an observation data package including data relating to the yield sign, the state of the vehicle, and the location. The navigation device generates a new smart contract on the MapCoin blockchain including the observation data package that identifies the navigation device as the originator. The vehicle then continues traversing the roadway. The smart contract may be verified and added to the MapCoin blockchain by other connected devices, for example, by using a proof of work mechanism. Subsequently, a second vehicle approaches and identifies the new yield sign. However, when querying the MapCoin blockchain, the second vehicle finds the smart contract generated by the initial vehicle. The second vehicle validates the observation data package and adds an identifier for the second vehicle to the smart contract as a validator. Additional vehicles may identify the new yield sign and further validate the observation data package. Eventually, there are enough validators for the smart contract to be fully validated. When the contract is fully validated, the smart contract may be executed, and rewards may be distributed to both the originator and each of the validators. A reward, may be for example, an amount of digital currency. To fund the reward, the consumption of map data may require an amount of digital currency. For example, a navigation device may pay an amount for using the HD map or for using the observation data package generated by the initial vehicle. By adding both the origination, the validation, and the reward to a MapCoin blockchain, the process is open, transparent, and market based.

As described here, a blockchain may be a collection of entries stored in a database whereby the current “state” of a blockchain may be ascertained by netting or otherwise totaling all the entries up to the current time. A database that includes distributed copies may be referred to as a replicated database. An example of an electronic replicated database is the “Blockchain” methodology employed, for example, by the Bitcoin digital currency. Blockchain is an electronic public replicated ledger in which transactions, such as those involving the cryptographic currency Bitcoin, are recorded.

A blockchain database is implemented by software that is executed by each device or node that is participating in the system. The software or application running on each node maintains a copy/replica of the blockchain data/database. The data stored in a blockchain is grouped into blocks where each block is coupled or linked, such as in a cryptographic manner, with a prior block forming a chain of blocks that may continue to grow as new data is added.

Each of the nodes communicate with the other nodes via a network, such as the Internet. The collection of nodes that participate in the blockchain may be referred to as the blockchain network. The blockchain software includes rules for allowing/verifying modifications, e.g. addition of new transactions, to the blockchain database by the operator of the node as well as for verifying and implementing modifications to the blockchain database received from other nodes. The rules are defined by the type of system the blockchain network is being used to implement, e.g. a system for payment of digital currency, and are coded into the software.

One implementation of a blockchain is Bitcoin which is a system for digital payment transactions. Users wishing to make or receive payments of a digital currency, called Bitcoin, construct transaction messages that document the transaction, e.g., the payee, the payor, the amount to paid/received, a source of funds, a cryptographic authentication, etc. The transaction is then submitted to the Bitcoin network for verification, e.g. to confirm available funds, authenticity of the payor, etc. Each node of the network receives the transaction and executes the rules implemented by the Bitcoin blockchain software to verify the transaction, e.g. ensure the payor has enough funds to cover the transaction and that no one is trying to spend the same Bitcoins twice, and then, if verified, record it in the blockchain database and notify other nodes of the modification thereto. Different blockchain software implementations may use different rules.

Each node may also be referred to as a “miner.” The process of verifying transactions and adding them to the blockchain database may be referred to as “mining.” In Bitcoin, miners are incentivized and rewarded for their effort via the award of a defined number of Bitcoins for being the first to complete the verification/blockchain modification process that by design is a non-trivial process.

In the Bitcoin blockchain, a block may only be added by solving a cryptographically defined computation based on the data to be stored in the block, data related to the prior block and an arbitrary value selected by the miner with a result of the computation having to meet specific requirements to be accepted. As the computations take time and may take many attempts by the miner to achieve a suitable result, in conjunction with the reward for success, the Bitcoin blockchain creates a competitive environment in which miners compete, e.g. using computing power, to be the first to successfully add a new block to the blockchain. The Bitcoin blockchain operates completely transparently, so all data is transmitted to, and is readable by, all participants in the Bitcoin system. That is, each party in the Bitcoin system, with some exceptions, maintains a copy of the ledger, stored by the blockchain, in which all transactions are recorded, referred to as “full replication.” In the case of Bitcoin, this replicated ledger makes all transaction “open transactions” and viewable by all participants on the blockchain network and is a necessary property required to prevent double spending of Bitcoins, i.e., parties attempting to send the same Bitcoin to multiple parties.

Using the replicated databases of blockchain along with cryptographically linking/chaining the transactions stored enables all users to ensure the reliability of the transaction data, i.e. that transactions are recorded accurately and subsequent thereto, protected from alteration, as each user has a copy of all of the transactions and any unintended alterations to a transaction, e.g. via errors or fraudulent activity, are readily detectable via both the cryptographic discrepancies within the chained transactions that would be created as well as the discrepancies that such alterations will create among the various copies of the blockchain ledger.

Blockchain technology may also be used to create applications that are beyond a digital currency. Such applications are often referred to as blockchain 2.0 and may be used for smart contracts. One example is the Ethereum network. Ethereum is an open-ended decentralized software platform that enables Smart Contracts and Decentralized Applications (Dapps) to be built and run using a blockchain network. Ethereum also includes a programming language (Turing complete) running on the blockchain, helping developers to build and publish distributed applications. The applications may be run on the blockchain using the programming language. The applications may be anything, for example, contracts that mechanically execute when certain conditions are met. Ethereum uses its own decentralized public blockchain to cryptographically store, execute, and protect the contracts. Each computer on the Ethereum network downloads a small virtual machine to sync with the Ethereum blockchain and remains available to execute smart contracts. The distributed network of computers provides the security, reliability, and computing power necessary for carrying out designed arrangements.

Smart contracts as referred to herein are computer protocols that embed the terms and conditions of a contract within computer code. The human readable terms (the source code) of a contract are compiled into executable computer code that can run on a network. Many kinds of contractual clauses may thus be made partially or fully self-executing, self-enforcing, or both. Blockchain technology enables smart contracts by building on the distributed ledger architecture. The code that makes up the smart contract may be added as part of an entry to the blockchain 2.0 application. Smart contracts make use of the trust mechanisms that are built into the blockchain as a database to provide that the contracts cannot be forged or tampered with. An example of a smart contract may be computer code that increments a value in one account and decrements a value in a second account when an event occurs. For example, pay company A one hundred tokens from company B's account when a delivery company verifies that a package has been delivered. The smart contract may be entered into and published to the blockchain where the smart contract is both immutable and transparent for all to view. If or when the event occurs, the smart contract is automatically executed.

Embodiments provide systems and methods for incentivizing HD map content collection by using transactional smart contracts and blockchain technology. New or changed features are observed by a device traversing a roadway. The device generates two or more smart contracts on a MapCoin blockchain that relate to the observation. The smart contracts provide for future vehicles or devices to validate the observation and to provide compensation to both the originator of the contracts and the validators. The smart contracts may further provide a mechanism that charges subsequent devices or vehicles for consumption of the observation data (e.g. providing a method of funding the compensation).

The disclosed embodiments may be implemented to provide a mechanism for incentivizing HD map data collection and consequently improving and optimizing navigation services. Feature discovery for navigation services may be facilitated. For example, features such as speed bumps, traffic signs, points of interest, accident location, event location, etc. may be more efficiently and quickly identified. The disclosed embodiments lead to an improvement in the computational system, e.g. in the way that roadway features data is validated using a decentralized mechanism. The increased efficiency and usage of resources may lead to less downtime, quicker implementation time, fewer errors, and as such, more efficient use of navigation services. The quicker implementation time and fewer errors may lead to more accurate up to date map data for navigation services.

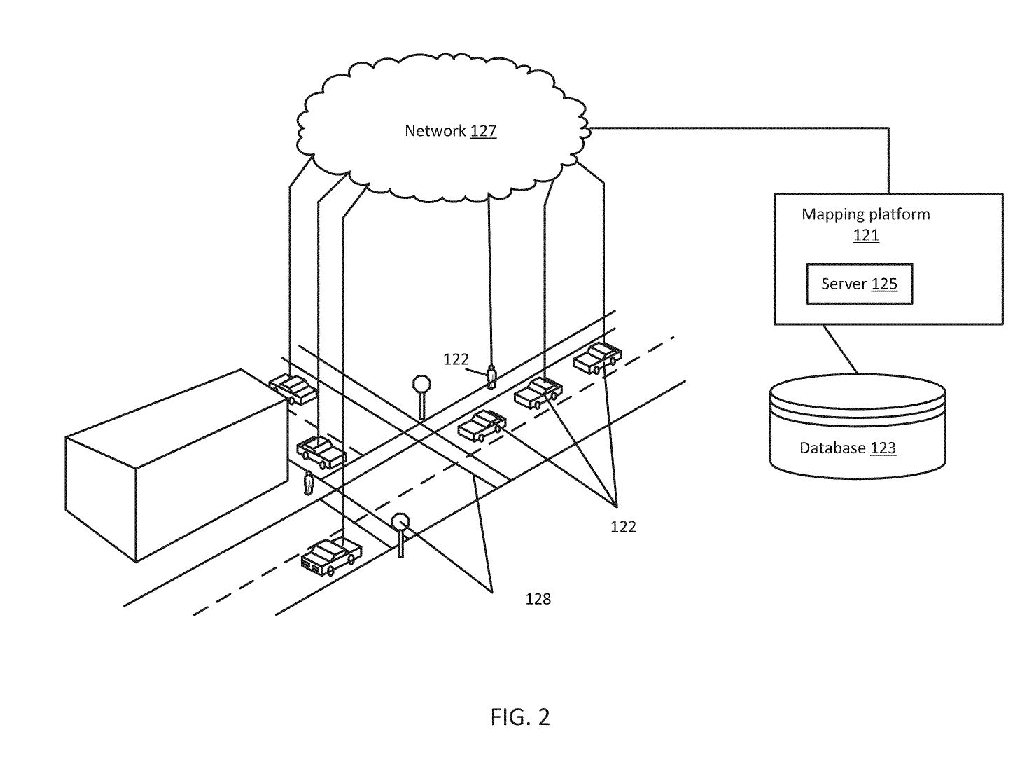

FIG. 2 depicts a system for incentivizing collection of HD map content. The system includes a plurality of devices 122, a network 127, and a mapping platform 121. The mapping platform 121 may include or may be connected to a database 123 (also referred to as a geographic database or map database or HD mapping database or HD map). The mapping platform 121 may include one or more servers 125. Additional, different, or fewer components may be included. FIG. 2 also depicts several roadway features 128. Roadway features may include any feature or object located near a roadway network.

The system includes a plurality of devices 122 (also referred to as nodes). The plurality of devices may include probe devices, probe sensors, or other devices 122 such as personal navigation devices 122, smart phones mount on a vehicle, or connected vehicles. The devices 122 may communicate with one another using the network 127. Each device 122 may be a lightweight, partial or full node of a MapCoin blockchain. Each device 122 may execute software configured to query the MapCoin blockchain and generate one or more smart contracts. Each device 122 may include a unique address and encrypted key that allows payment to and from the device 122 to other devices using the MapCoin blockchain.

The mapping platform 121 may also communicate with the devices 122 through the network 127. The mapping platform 121 may also receive data from one or more systems or services that may be used to identify the location of a vehicle, roadway features, or roadway conditions. The device 122 may be a navigation system built into the vehicle and configured to monitor the vehicle. The devices 122 may also be integrated in or with a vehicle. The devices 122 may include mobile phones running specialized applications that collect location data as the devices 122 are carried by persons or things traveling the roadway system. The devices 122 may be configured to collect and transmit data including the location of a vehicle and other geospatial data. The devices 122 may be configured to monitor conditions near the vehicle. The devices 122 may be configured to provide guidance for a user or vehicle.

The device 122 may be configured to acquire and transmit map content data on the roadway network to the mapping platform 121. As depicted in FIG. 2, the device 122 may be configured to identify a roadway feature 128 (or identify a change or removal of a feature) and the location of the roadway feature (approximation using positional circuitry or image processing). The identification of the roadway feature 128 and location may be referred to as observational data. Observational data may include positional coordinates such as latitude and longitude derived from a positioning system such as GPS. Observational data may include a description of the feature (e.g. signage, point of interest, or other roadway feature).

The observational data may be formatted by the device 122 and uploaded for validation by the other devices 122 and/or the mapping platform 121. In return for identifying and uploading the observational data points, the device 122 may be rewarded with an amount of digital currency. The amount of digital currency may depend on the type of feature, location, timing, and other factors. For example, some devices may be able to more accurately position a detected feature and thus may be able to earn more digital currency for validating/improving another observation. The amount of digital currency awarded may also depend on whether the device 122 is the first device 122 to observe the feature (or change/removal of the feature) or if the device 122 is validating another device's observation. Once a feature or change has been identified, validated, and appended to a MapCoin blockchain, future vehicles or devices 122 that use the feature data may be charged an amount of digital currency to provide the award to the identifiers or validators. In this way, collection and validation of observational data points may be incentivized.

The mapping platform 121 and devices 122 are connected to the network 127. The devices 122 may receive or transmit data through the network 127 to the other devices 122 or the mapping platform 127. The mapping platform 121 may receive or transmit data through the network 127. The mapping platform 121 may also transmit paths, routes, or feature data through the network 127. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMax (Worldwide Interoperability for Microwave Access) network, DSRC (otherwise known as WAVE, ITS-G5, or 802.11p and future generations thereof), a 5G wireless network, or wireless short-range network. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols.

The mapping platform 121 may include multiple servers 125, workstations, databases, and other machines connected and maintained by a map developer. The mapping platform 121 may be configured to receive and process observational data from devices 122 in the roadway. The mapping platform 121 may be configured to identify, verify, and augment features and locations of the features from the observational data. The mapping platform 121 may be configured to update a geographic database 123 with the features and locations. The mapping platform 121 may be configured to provide feature data and location data to devices 122. The mapping platform 121 may also be configured to generate routes or paths between two points (nodes) on a stored map. The mapping platform 121 may be configured to provide up to date information and maps to external geographic databases 123 or mapping applications. The mapping platform 121 may be configured to encode or decode map or geographic data. Feature data may be stored by the mapping platform 121 using geographic coordinates such as latitude, longitude, and altitude or other spatial identifiers. The mapping platform 121 may acquire data relating to the roadway though one or more devices 122.

The mapping platform 121 may be implemented in a cloud-based computing system or a distributed cloud computing service. The mapping platform 121 may include one or more server(s) 125. A server 125 may be a host for a website or web service such as a mapping service and/or a navigation service. The mapping service may provide maps generated from the geographic data of the database 123, and the navigation service may generate routing or other directions from the geographic data of the database 123. The mapping service may also provide information generated from attribute data included in the database 123. The server 125 may also provide historical, future, recent or current traffic conditions for the links, segments, paths, or routes using historical, recent, or real time collected data. The server 125 may receive updates from devices 122 or vehicles on the roadway regarding the HD map. The server 125 may generate routing instructions for devices 122 as a function of HD map updates stored on the MapCoin blockchain.

The mapping platform 121 includes the geographic database 123. To provide navigation related features and functions to the end user, the mapping platform 121 accesses the geographic database 123. The mapping platform 121 may update or annotate the geographic database 123 with new or changed features based on observational data from the plurality of devices 122. The plurality of devices 122 may also store a full or partial copy of the geographic database 123.

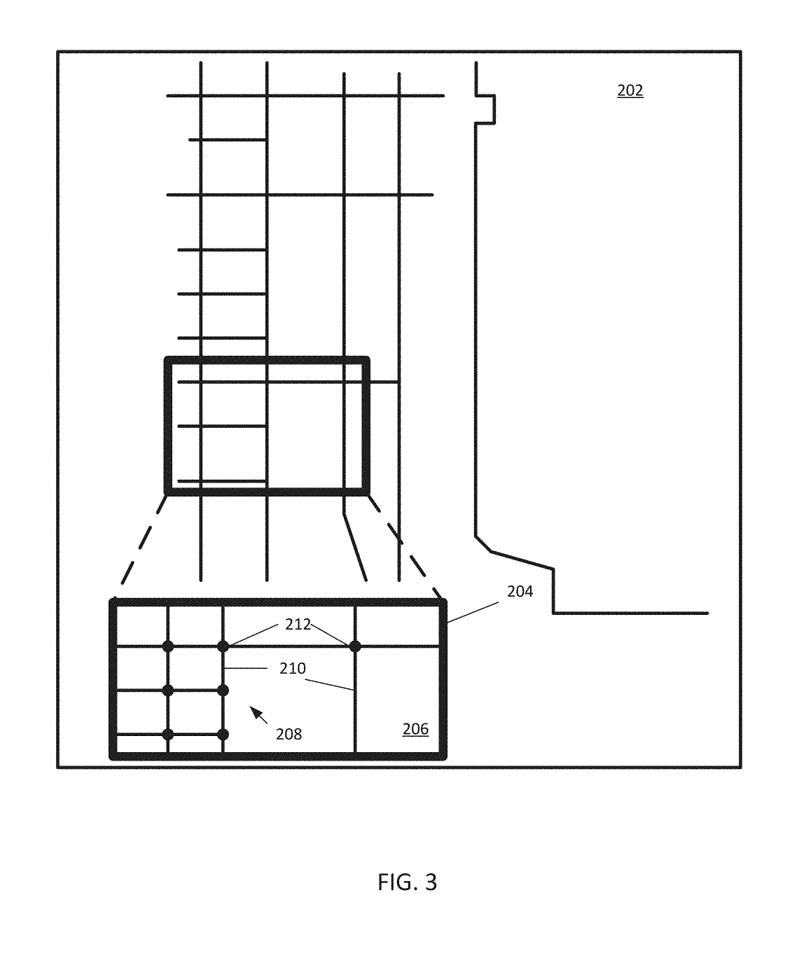

The geographic database 123 includes information about one or more geographic regions. FIG. 3 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc.

FIG. 3 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Each road segment 210 is shown to have associated with it two nodes 212; one node represents the point at one end of the road segment and the other node represents the point at the other end of the road segment. The node 212 at either end of a road segment 210 may correspond to a location at which the road meets another road, i.e., an intersection, or where the road dead ends.

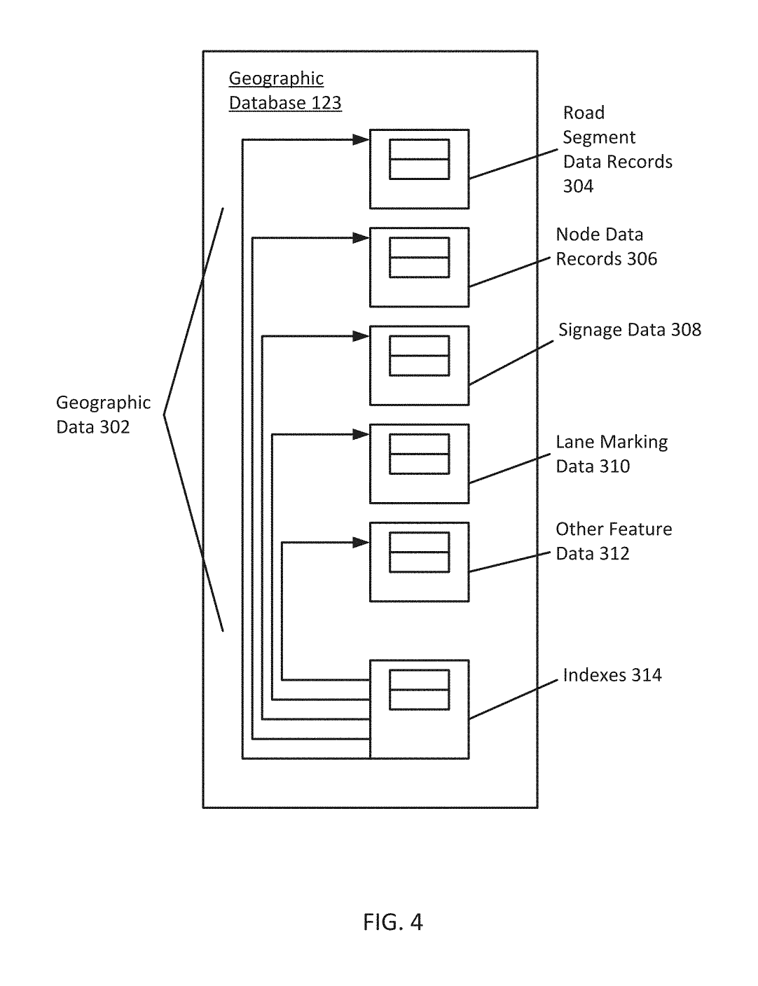

As depicted in FIG. 4, in one embodiment, the geographic database 123 contains geographic data 302 that represents some of the geographic features in the geographic region 202 depicted in FIG. 3. The data 302 contained in the geographic database 123 may include data that represent the road network 208. In FIG. 4, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include feature data 308-312. The feature data 312 may represent types of geographic features. For example, the feature data may include signage records 308 that identify the location of signage on the roadway. For example, the signage data 308 may include data for one or more signs (e.g. stop signs, yield signs, caution signs, etc.) that exist on the roadway network. The feature data may include lane features 310 that indicate lane marking on the roadway. The other kinds of feature data 312 may include point of interest data or other roadway features. The point of interest data may include point of interest records comprising a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc. The feature data may also include painted signs on the road, traffic signal, physical and painted features like dividers, lane divider markings, road edges, center of intersection, stop bars, overpasses, overhead bridges etc. The feature data may be identified from observational data received by the devices 122. More, fewer or different data records can be provided. In one embodiment, additional data records (not shown) can include cartographic (“carto”) data records, routing data, and maneuver data.

The feature data 308-312 may include HD mapping data that may model road surfaces and other map features to decimeter or centimeter-level or better accuracy. The feature data 308-312 may also include lane models that provide the precise lane geometry with lane boundaries, as well as rich attributes of the lane models. The rich attributes include, but are not limited to, lane traversal information, lane types, lane marking types, lane level speed limit information, and/or the like. In one embodiment, the feature data 308-312 are divided into spatial partitions of varying sizes to provide HD mapping data to vehicles 101 and other end user devices 122 with near real-time speed without overloading the available resources of the devices 122 (e.g., computational, memory, bandwidth, etc. resources). The feature data 308-312 may be created from high-resolution 3D mesh or point-cloud data generated, for instance, from LIDAR-equipped vehicles. The 3D mesh or point-cloud data are processed to create 3D representations of a street or geographic environment at decimeter or centimeter-level accuracy for storage in the feature data 308-312. FIG. 1 depicts an example of a 3D representation of a geographic environment.

In an embodiment, the feature data 308-312 also include real-time sensor data collected from probe vehicles in the field. The real-time sensor data, for instance, integrates real-time road event data, traffic information, weather, and road conditions (e.g., potholes, road friction, road wear, etc.) with highly detailed 3D representations of street and geographic features to provide precise real-time feature detection at decimeter or centimeter-level accuracy. Other sensor data can include vehicle telemetry or operational data such as windshield wiper activation state, braking state, steering angle, accelerator position, and/or the like. In one embodiment, these sensor data can be used to report road events and their associated confidence levels determined according to the various embodiments described herein.

The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304. As another example, the indexes 314 may relate feature data such as the signage records 308 with a road segment in the segment data records 304 or a geographic coordinate. The indexes 314 may also store repeating geometry patterns or relationships for links or nodes that represent repeating geometry patterns.

The geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout the geographic region to observe features and/or record information about the roadway. Also, remote sensing, such as aerial or satellite photography, can be used.

As depicted in FIG. 2, the system includes a plurality of devices 122 communicating with one another over a network 127. Each of the devices 122 may include one or more sensors. The sensors may include radar, infrared, ultrasonic, and vision-oriented sensors, such as digital video cameras and LIDAR among others.

Each of the devices 122 may store a copy of a portion of a geographic database 123 or a full geographic database 123. As described above, the geographic database 123 may include data for HD mapping. An HD map or HD map data may be provided to the devices 122 as a cloud-based service. The HD map may include one or more layers. Each layer may offer an additional level of detail for accurate and relevant support to connected and autonomous vehicles. The layers may include, for example, a road model, a lane model, and a localization model. The road model provides global coverage for vehicles to understand local insights beyond the range of its onboard sensors such as high-occupancy vehicle lanes, or country-specific road classification. The lane model may provide more precise, lane-level detail such as lane direction of travel, lane type, lane boundary, and lane marking types, to help self-driving vehicles make safer and more comfortable driving decisions. The localization layer provides support for the vehicle to localize itself in the world by using roadside objects like guard rails, walls, signs and pole like objects. The vehicle identifies an object, then uses the object's location to measure backwards and calculate exactly where the vehicle is located.

In an embodiment, the HD map data and geographic mapping data may be updated by monitoring the MapCoin blockchain. The MapCoin blockchain may store a record of new and validated observations on the roadway. The server 125 may monitor and make changes to the geographic database 123 that are recorded to the MapCoin blockchain. In an embodiment, the server 125 may be charged a portion of digital currency (e.g. MapCoin) to access and pull records (data entries/contracts) from the MapCoin blockchain. Alternatively, the MapCoin blockchain may be publicly available for anyone to view. In an embodiment, only devices that are part of the MapCoin blockchain, e.g. operating as nodes, may have access to the data on the MapCoin blockchain.

The geographic database may be a master geographic database stored in a format that facilitates updating, maintenance, and development. For example, the master geographic database or data in the master geographic database may be in an Oracle spatial format or other spatial format, such as for development or production purposes. The spatial format or development/production database may be compiled into a delivery format, such as a geographic data files (GDF) format. The data in the production and/or delivery formats may be compiled or further compiled to form geographic database products or databases, that may be used in end user navigation devices 122 or systems.

In an embodiment, the geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device 122, such as by a vehicle, for example. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received geographic database in a delivery format to produce one or more compiled navigation databases.

The geographic database may represent a compiled navigation database that may be used in or with the devices 122 to provide navigation-related functions. For example, the geographic database 123 may be used with the devices 122 to provide an end user with navigation features including road event alerts. In such a case, the geographic database 123 may be downloaded or stored on the devices 122 or the end user device 122 may access the geographic database 123 through a wireless or wired connection (such as via a server and/or the communication network 127), for example. Furthermore, the geographic database 123 or compiled features thereof may be provided as a cloud service.

In an embodiment, the geographic database 123 is presented according to a hierarchical or multi-level tile projection. The geographic database 123 may be defined according to a normalized Mercator projection. Other projections may be used. In one embodiment, a map tile grid of a Mercator or similar projection can form a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached. As previously described, the road event data records may be associated with any of the map tiles to indicate that a road event has been detected in the geographic area represented by the map tile.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid may include 2\hat{ }n cells. Accordingly, any tile of the level (n) has a geographic area of A/2\hat{ }n where A is the total geographic area of the world or the total area of the map tile grids. Because of the numbering system, the exact position of any tile in any level of the map tile grid or projection may be uniquely determined from the tile ID.

The geographic database 123 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located. The geographic database 123 may in part be represented in the MapCoin blockchain using the tile-based structure. For example, observations (and contracts) may be stored in the MapCoin blockchain in a spatially organized structure. By parsing the MapCoin blockchain, an application may be able to reconstruct a full or partial representation of the geographic database 123. Each of the one or more devices 122 may store a copy of a portion of or a full MapCoin blockchain database.

To maintain the HD map, each device 122 may collect and share information with other devices 122 over the network 127. The devices 122 may identify changes to the roadway while traversing the roadway. When a device 122 observes a change (e.g. a difference between an existing HD map and sensor data) the device 122 may generate an observation data package that includes data relating to the change and positional data. The device 122 may communicate the observation data package to other devices 122 by using a MapCoin blockchain as detailed below. The device 122 may also communicate the observation data package to the mapping server for inclusion in the geographic database 123. The mapping server may monitor the MapCoin blockchain for validated changes and make updates as such.

The communication network 127 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, devices 122 and the mapping platform 121 communicate with each other and other components over the communication network 127 using well known, new or still developing protocols. In this context, a protocol includes a set of rules defining how the network nodes within the communication network 127 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

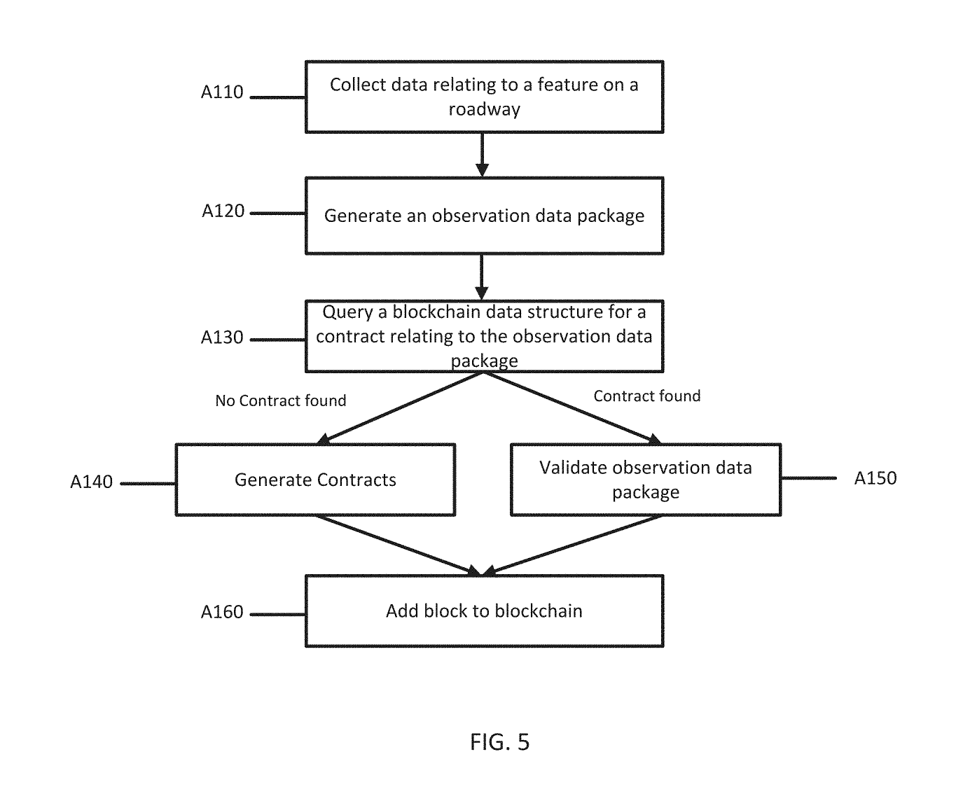

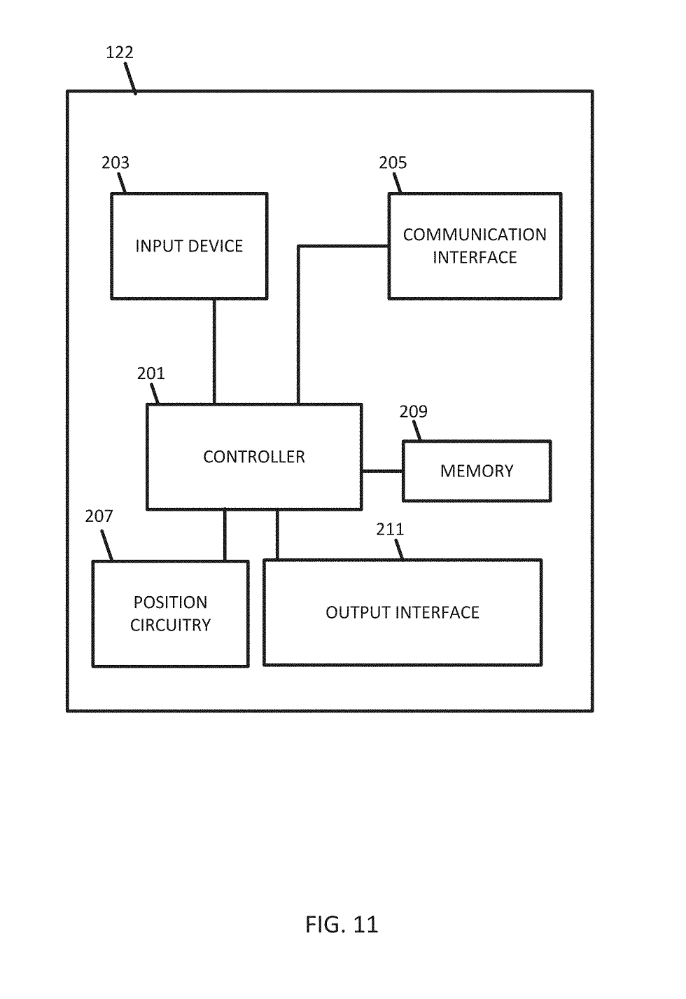

In an embodiment, the devices 122 communicate with one another over the network to identify and validate observations on a roadway network. Users or devices 122 are incentivized to collect and validate map data using a decentralized MapCoin blockchain. FIG. 5 depicts an example workflow for incentivizing and validating collected map data. As presented in the following sections, the acts may be performed using any combination of the components indicated in FIG. 2 or FIG. 11. The following acts may be performed by the server 125, the device 122, the mapping platform 121, or a combination thereof. One or more nodes (devices 122) of the MapCoin blockchain may perform portions of the Acts. Additional, different, or fewer acts may be provided. The acts are performed in the order shown or other orders. The acts may also be repeated. Certain acts may be skipped.

At act A110, a navigation device 122 collects data relating to a feature on a roadway. The navigation device 122 may use different sensors such as cameras, LIDAR, radar, ultrasonic, or other sensors. Different types of data may be collected by a navigation device 122. For example, data relating to roadways such as road lanes, road edges, shoulders, dividers, traffic signals, signage, paint markings, poles, and all other critical data needed for the safe navigation of roadways and intersections by autonomous vehicles may be observed and collected. The navigation device 122 may collect data that relates to a new feature, a removal of a feature, or the alteration of a feature. The navigation device 122 may store a copy of an HD map in a local database. The navigation device 122 may identify features that are different from the features that are in the HD map. For example, the navigation device 122 may identify signage using a LIDAR sensor that does not exist in the local HD map. The navigation device 122 may determine that a lane that is recorded in the local HD map is no longer present on the roadway. The navigation device 122 may identify that a road edge has moved and no longer exists in the same place as specified in the HD map. For each observation, the navigation device 122 may also collect positional data relating to the observation and device data relating to the operation or state of a vehicle.

At act A120, the navigation device 122 generates an observation data package (ODP). The device 122 may constantly collect data while traveling a roadway. Raw unformatted data from a camera may quickly overload any transmission system. The raw sensor data (e.g. images, LiDAR, radar, etc.) used by on-vehicle sensor processing systems to detect and triangulate the coordinates of an object may not be included as part of the ODP. Rather, the ODP may include a description of the alteration and locational data derived from the raw sensor data. The device 122 may format and compress the sensor data into easily read ODPs. The ODP may be used to transfer and communicate roadway environmental models in a standardized, compact form between vehicles and to the mapping platform 121. The format of the ODP may include at least a description of the object (or lack of object) and positioning data. In addition, the ODP may include data that represent a state of the observer (e.g. the positioning or location of the vehicle).

The description of the observation may include data about a feature of the roadway. Features may include roadside and overhead signs, lane markings, road boundaries, roadway barriers, road surface markings, pole like objects (sign posts, traffic light posts, retro-reflective posts, etc.), construction zone elements, and traffic signals among other features. The features may be permanent or non-permanent. An example of a non-permanent feature may be a construction element, road blockage (e.g. fallen tree), pothole, or other feature that be transitory. The description of the feature may include a description of an absence of a feature. For example, when traversing a roadway, the device 122 may observe that a feature that exists in the HD map does not exist on the actual roadway. A pothole, for example, may have been filled; a sign may have been removed, a lane may have changed. The state of the observer may include, for example, the orientation of a vehicle (roll, pitch, and yaw) or the relative location of the vehicle to an identified point. The position of the feature and the position of the vehicle may be denoted by using one or more coordinate systems. A Global World Coordinate System as Earth Centered Earth Fixed (ECEF, ITRF2014) may be used. Other coordinate systems such as a Local Cartesian Coordinate Systems defined at each Pose Point (LCS) or a Vehicle Coordinate System (VCS) may also be used to describe the location of the feature or the vehicle. The ODP may include other information such as a link to a data repository, a map version, a link identifier, a tile identifier, or other relevant data.

In an embodiment, the ODP may also include a quality value associated with the observation. The quality value may be defined in a variety of different manners. In one embodiment, the quality value includes a quality prediction for accuracy of an object (a geospatial accuracy error representative of an absolute position error value for a respective object), a quality prediction for existence confidence of the object and/or a quality prediction for classification confidence of the object.

The quality value may be based on the sensor quality or processing power of the vehicle or navigation device 122. For example, when comparing observations of the same object by different sensors and different devices 122, the observations may differ in quality. One type of sensor may provide more accurate observational data than another. One type of sensor may function better in certain conditions. A newer sensor may function better than an older sensor. Additionally, certain navigation devices 122 may process observational data better than other navigation devices 122. For example, a navigation device 122 that is built into a vehicle and is programmed specifically to identify features on a roadway may generate more accurate descriptions of features than a standard smartphone. The quality value may further be calculated as a function of environmental factors. Observations during inclement weather may result in low quality (e.g. less accurate) observations. Observations during the night or on low illuminated roadways may be less accurate.

The quality value may be generated as a function of a quality value algorithm that may be updated or adjusted over time. In an embodiment, the mapping server may adjust the quality value algorithm based on actual observations and ground data. Observations that are correctly identified may result in higher quality values for the responsible sensors, processing, or environmental factors.

In an embodiment, the ODP does not include a quality value. The navigation device 122 may only generate ODP's that exceed a quality value. For example, a navigation device 122 may determine if an observation exceeds an accuracy or quality threshold prior to generating the ODP. The accuracy or quality threshold may be determined as a function of an algorithm or formula that may be updated or adjusted based on feedback or ground truth data. Alternative formats for the ODP may be used. The size of the ODP may be limited by the amount of bandwidth available. The ODP may be compressed or uncompressed.

At act 130, the navigation device 122 identifies in a data structure if there is an existing data entry (contract transaction) for the ODP. The data entry may include data relating to the ODP including a smart contract that describes reward logic for collection, validation, and consumption of the ODP data. The ODP may include at least an observation and a location. Once the ODP is generated, a spatial query is run against a MapCoin blockchain to identify if there is an existing data entry for the location. The entirety of the MapCoin blockchain may be stored locally in the navigation device 122. Alternatively, the navigation device 122 may only store a portion of the MapCoin blockchain. The data structure of the MapCoin blockchain may include a spatially organized tree that include data (e.g. smart contracts) for a plurality of observation data packages. The spatially organized tree may be a data structure that is organized by location, e.g. using a coordinate system to identify the location or address of the data entries in the blockchain.

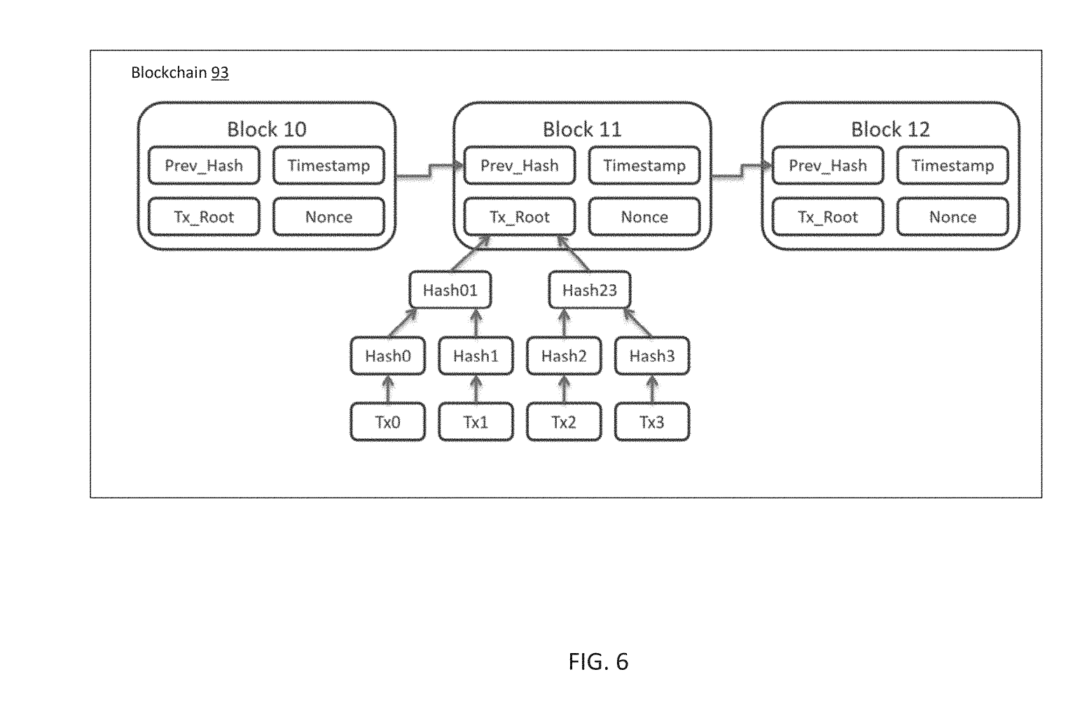

FIG. 6 illustrates an example blockchain 93. The blockchain 93 is made up of a series of blocks, block 10, block 11, and block 12. Each block is built on a hash of a previous block, linking all the blocks together. For example, block 11 is constructed using a hash (Prev_Hash) of block 10. Block 11 further contains a timestamp, Tx_Root (transactional data), and Nonce (a value that is used as a proof of work). A portion of each block (e.g. the Tx data) may include code that enables a smart contract. As such, a smart contract is a piece of code that “lives/executes” within the blockchain on every node within the network. The smart contract is a compiled byte code (e.g. mini program) that is executed on each node. For the smart contract to be valid, all nodes within the blockchain agree (by majority vote) that the smart contract was executed, and all the results agree before a transaction occurs.

In an embodiment, the MapCoin blockchain stores the contract transaction data in a spatially organized tree-based data structure. The transaction lists are stored locally in a tree (also referred to as a trie) and serialized to lists to send to clients requesting the MapCoin blockchain. In an embodiment, the key under which the ODP value is stored is encoded as the “path” to he taken down the tree and is based on the geographic location included with the ODP. A tree may also be referred to as a radix tree. In a radix tree, the key is the actual path taken through the tree to get to the corresponding value. That is, beginning from the root node of the tree, each character in the key identifies the child node to follow to get to the corresponding value, where the values are stored in the leaf nodes that terminate every path through the tree. In an embodiment, a Merkle-Patricia tree structures is used to spatially store the contract transaction data.

Other tree structures may be used to store the contract transaction such as R-trees, quadtrees, or octrees. R-trees, quadtrees, and octrees are tree data structures used for spatial access methods. In a spatial access method, the data structure is organized using geographical coordinates or tiles. Each node in an octree subdivides the space the octree represents into eight octants. In a point region octree, the node stores an explicit three-dimensional point, which is the “center” of the subdivision for that node; the point defines one of the corners for each of the eight children. In a matrix-based octree, the subdivision point is implicitly the center of the space the node represents.

At act A140, if the query identifies no data entries for the ODP, at least two smart contracts are created and written to the MapCoin blockchain. The smart contract code within transactions of blocks may be immutable (not modifiable), however, storage for contracts may not be. The first contract for the ODP is a logic contract that stores the transaction logic to calculate the amount of MapCoin to be transferred from senders to recipients. The second contract is a storage contract that stores the identities of the senders and recipients. The transaction logic may include a formula or equation that calculates an amount of MapCoin. The formula may use multiple input such as a quality index predictive model, an age of the given ODP, and the number of other creators and validators of the ODP, if any.

A quality index predictive model may be used to identify observation data that is of high quality. Observation data and the generated ODP may vary from low quality to high quality depending on the type of sensor, environmental factors, the processing capability of the navigation device 122, and other factors. As described above, a quality value may represent the confidence level that an observation is accurate, e.g., the confidence in the correct representation of a map object. For example, the existence confidence provides a measure of whether the existence of the object represented by the map is a true or false positive. A low-quality value may indicate that the observation data is suspect. A high-quality value may indicate that the observation data is accurate. The quality index may also identify whether the object or an attribute of the respective object has been correctly classified. For example, an observation may be identified by a device 122 as a first type of signage when the object or feature is actually a different type of signage.

The immutable logic contract for the ODP stores the address of the contracts (senders and recipients) to call in the second, mutable (modifiable) storage contract. Each node or device 122 that participates in the MapCoin blockchain may be assigned an address or wallet that stores an amount of digital currency (e.g. MapCoin) that each node or device 122 possesses. The address or wallet may require a digital signature from the node or device 122 to be accessed. The modifiable storage contract may be configured to only accept read and write calls from trusted addresses (the logic contract). In the storage contract the sender arid recipient lists are created. When the contract is executed, an amount of token MapCoin) is transferred from senders to recipients in a single state transition in accordance with the logic contract. As logic and storage contracts are created, a wallet address or account number of the creator of the ODP is appended to the recipient list.

The logic contract may store multiple addresses of the contracts to call in the second, modifiable storage contract. The storage contract may include multiple different list fields. In an embodiment, the two lists are senders and recipients. Additional lists may include lists for the driver of the vehicle, the specific navigation device 122, the OEM of the vehicle, a fleet owner, a sensor provider, a passenger, for rentals, and other potential parties. In an example, rewards may be provided to both the driver and the navigation device 122 of the vehicle if, for example, the vehicle is a rental. A passenger in an autonomous vehicle may be rewarded as well as the autonomous vehicle. A company that rents out or loans sensor equipment may be rewarded along with the vehicle. Different award schemes may be generated and called by the logic contract according to a set of agreed upon rules.

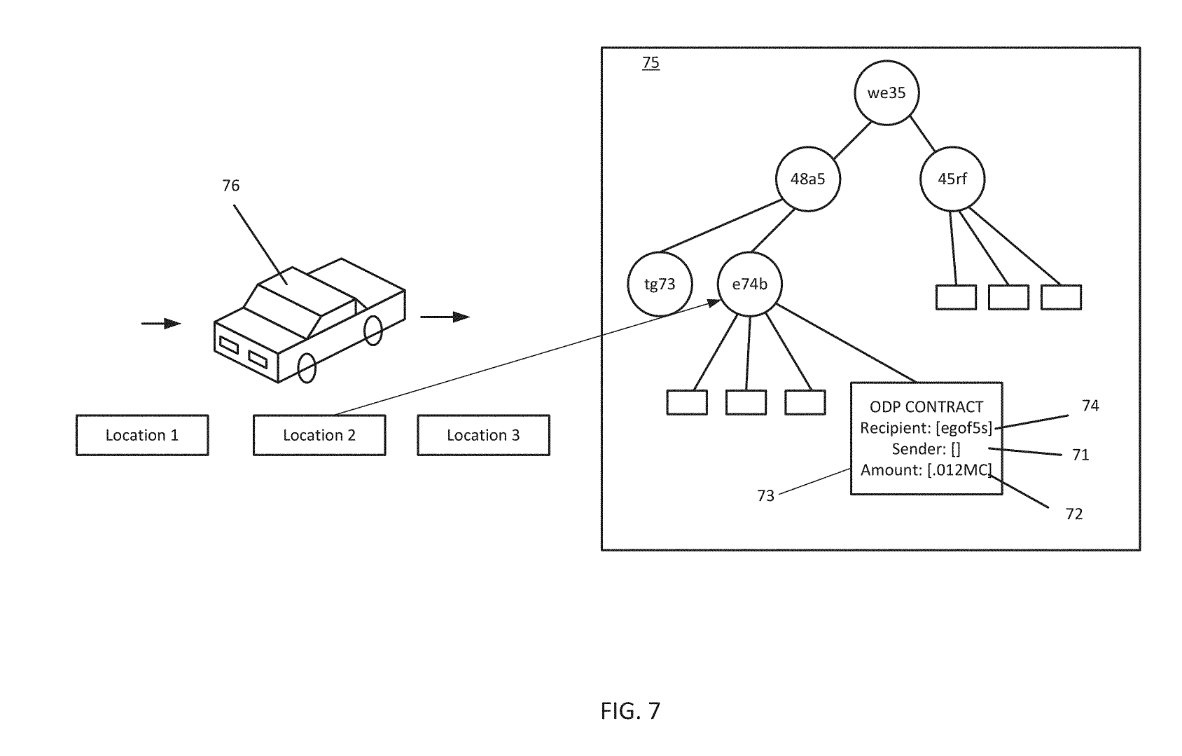

FIG. 7 depicts an example of contract generation. The vehicle/device 76 traverses a roadway moving from location 1 to location 2 to location 3. At location 2, the vehicle 76 identifies a new feature on the roadway. The vehicle 76 queries a blockchain 75 that is spatially organized. As depicted, the node e74b relates to location 2. As depicted, location 2 may have multiple ODP contracts relating to the location. If the vehicle 76 does not find an existing contract for the new feature, the vehicle generates at least one contract 73 that includes logic for rewarding an amount 72 of digital currency to a list of recipients 74 (here 0.012MC e.g. 0.012 MapCoin). The amount of digital currency is withdrawn from a list of senders 71. The vehicle may add its address to the recipients list (egof5s) to receive a reward. At this point, the sender's list is empty. The addresses (wallets) of the recipients and senders may be stored in a mutable (changeable) storage contract also generated by the vehicle 76 and stored in the blockchain. The ODP contract, once generated may be transmitted to other devices 122/nodes in the blockchain to be verified and added to the blockchain.

The new data entries are stored with the geographic location of the ODP itself within the tree data structure (Merkle-Patricia, R-tree, octree, etc.). The tree is stored within a block and waits to be mined and added to the MapCoin blockchain. After the data entries are generated, they are transmitted to other devices 122/nodes in the MapCoin blockchain to be added to a block, verified, and added to the MapCoin blockchain.

At act A150, if a contract is found at act A140, the existing contract, and the associated ODP, is validated by the device 122. In an embodiment, the ODP may be validated by subsequent devices 122/nodes that traverse the roadway. While an initial observation is important, validating that observation is equally as important for updating the HD map database. Similar to acts A110-A130, when a vehicle or navigation device 122 observes a new or changed feature, the navigation device 122 queries the MapCoin blockchain to determine if a contract transaction exists. For the validation process, a prior contract transaction is identified on the MapCoin blockchain. The contract transaction may include information regarding the observation. For example, the contract transaction may include a feature type, a location, and a time of the initial observation. The contract transaction may further include a link to additional ODP data or may include the ODP data. The contract transaction may also include a reward for validators of the observation. In the case of ODP validation, the terms and code of the logic contract transaction are immutable as mentioned above. ODP validation is a function of contract discovery to augment the storage contract immutably associated with the logic contract. Once the contract transaction is discovered, a wallet address of the validator is appended to the recipients list, and the amount of MapCoin awarded to all recipients is adjusted accordingly.

A contract transaction may be executed once a predefined number of validators have validated the observation or when a consistency metric has converged to a low-enough value. Higher quality detections will converge the consensus faster than lower-confidence sensors. In an example, after an initial observation, a contract transaction is generated and transmitted for the ODP. Terms of the contract may indicate that the transaction would execute (e.g. dispense the amount of MapCoin) after the transaction is validated by five separate additional devices 122. The execution of the transaction may be a function of the quality or quantity of the observation. In the example above, only four separate additional devices 122 may be required to validate the contract depending on, for example, the sensor quality of the devices 122. The required consistency metric (quality value) for validation may be determined or defined as a function of the type of feature. Certain features may be more difficult to detect or may require more precise (and validated) observations. The quantity of validators may also be calculated as a function of the type of feature. The execution of the transaction may also be based on a temporal value. For example, the transaction contract may self-execute after a certain amount of time. The quantity or quality may also be based on a temporal value. For example, an older observation may be given less weight than a newer observation or validation.

In an embodiment, the ODP may require validation by a mapping organization. For example, the ODP may be transmitted to a mapping server that validates the ODP for either formatting or substance. The mapping server that validates the ODP may also receive a reward and may be added to the storage contract.

In an embodiment, different validators may be treated differently when calculating a reward or payment. The storage contract may include different fields for different parties that validate the observation. An institutional or fleet of vehicles may be rewarded differently than an unaffiliated party. A separate reward may be generated for a mapping organization or company that maintains the HD map. The level of reward may be based on the quality of the validation or creation. A vehicle that includes a full array of sensors (LIDAR, radar, ultrasonic, etc.) may be rewarded more or less than a vehicle that is reporting or validating using a standard smartphone.

In an embodiment, the amount of MapCoin awarded to all recipients is calculated based on the location of the ODP. The amount of MapCoin may be calculated based on the type of feature. For keeping an up to date version of an HD map, certain features and areas may be more important than others. A rural road, for example, that is not travelled very often may require fewer updates than an urban high traffic throughway. Certain areas may be altered more often than others. An area that includes more construction zones may be altered more often than other areas. Certain features may also be more vital in updating an HD map. Certain signage, for example, a stop sign, may provide more information to a vehicle when traversing a road than, for example, an advertisement or billboard. Both features may be included in the HD map, but the priority for identifying and validating the features may be reflected in the amount of MapCoin awarded for both creation and validation.

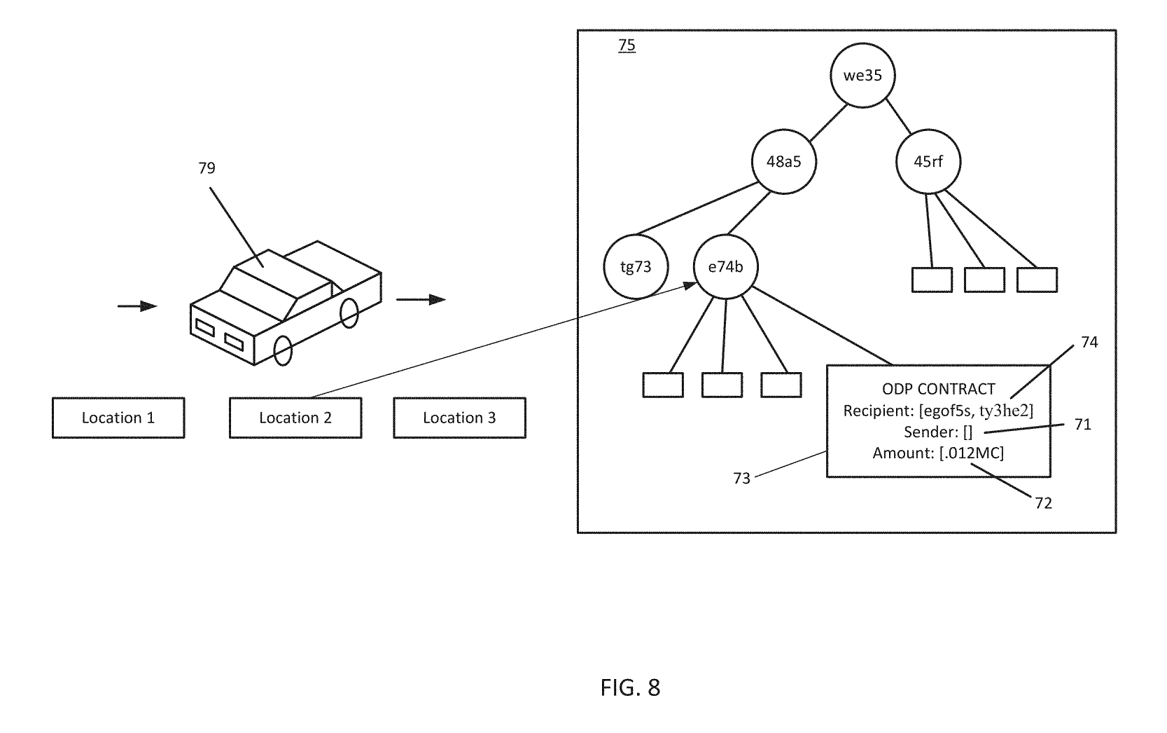

FIG. 8 depicts an example of contract validation. Subsequent to the process of FIG. 7, a second vehicle 79 traverses the roadway and comes across location 2. The second vehicle also identifies the feature and queries the blockchain structure 75. Finding an existing ODP contract, the second vehicle validates the ODP and adds its address (ty3he2) to the recipient's list 74 in the mutable storage contract. The senders list 71 remains empty and the amount 72 does not change as the logic contract may be immutable. The ODP contract, once augmented may be transmitted to other devices 122/nodes in the blockchain to be verified and added to the blockchain. After a predefined number (based on quality/rules/etc.) of validators the contract may be executed, and the amount of MC is transferred. At this point, as there are no senders, if the contract was executed, no amount of MC would be transferred.

In an embodiment, if the contract transaction is executed, additional information may be requested from the navigation device 122. For example, when a ODP is generated, the navigation device 122 may store the sensor data used to generate the ODP. If the ODP is later validated, the navigation device 122 may transmit the sensor data to a mapping server for processing and implementation into the HD map database.

At act A160, the contract transaction (either new or updated) is added to a block and transmitted to other devices 122 to be mined. When the contract transaction is mined and added to the blockchain, compensation is provided to the navigation device 122. The contract transaction (logic contract) may be executed at the point in time when the block is mined. Mining of the block may be done by other nodes (devices 122) in the MapCoin blockchain. As described herein, each node may be referred to as a “miner” and the process of verifying transactions and adding them to the MapCoin blockchain database may be referred to as “mining.” Miners are incentivized and rewarded for their effort via the award of a defined amount of MapCoin for being the first to complete the verification/blockchain modification process, which, by design is a non-trivial process. The incentivizing/reward process is also implemented by the MapCoin blockchain software as are rules for determining which node was the first to complete the verification/blockchain modification process for a given set of transactions.

MapCoin may be mined using any mining process. Mining is the process in which a block in the MapCoin blockchain is verified and added. Different methods may be used to avoid a double spending or falsification problem. For example, a proof of work method may be used. Alternatively, a proof of stake method may also be implemented. Either method of mining may be used to verify new transactions in the MapCoin blockchain. In an embodiment, mining solves for a proof-of-work number and allows the block to be appended to the chain. The mining process may be conducted by nodes in the network. As a reward for solving a complex calculation, a portion of MapCoin may be awarded. The complexity of mining using proof of work may be set to dis-incentivize malicious actors from attempting to offer up multiple differing yet self-consistent ledgers thereby solving the double-spend problem and fends off Sybil attacks.

The contract transaction for the given ODP is executed at the point in time when the block is mined, e.g. when the transactions within the block have been validated and officially added to the MapCoin blockchain. At this time, the transfer of MapCoin occurs from the senders to the recipients in accordance with the logic immutably encoded in the logic contract.

If or when a new device 122 validates or consumes the ODP, the contract may be altered. For example, when a new device 122 validates the ODP, the new device 122 adds its identifier to the storage contract. When a new device 122 consumes the ODP, the new device 122 adds its identifier to the storage contract as sender. When a contract is altered, the alternated contract is again added to a block and awaits mining by the MapCoin blockchain.

MapCoin may not be continually transferred. Each logic contract may include an end of life or maximum senders. For example, a logic contract may specify that the storage contract may close within a certain period, e.g. a day, a week, a month, or other time frame. The logic contract may also specify a maximum number of senders (and validators). For example, the logic contract may specify that only the first 100 or 1000 “consumers” will be added to the senders list. By ending the list or contract, rewards (and costs) are capped for each ODP incentivizing new observations or validations while also not burdening new entrants with all the costs but none of the awards.

In an embodiment, a fee may be imposed on all contracts above and beyond the normal fee required to process the contract. For example, when a contract is created, N % of the contract fund (˜0.5% for example) is removed and distributed to an account/wallet of the mapping server.

In an embodiment, the ODPs are consumed and paid for by subsequent devices 122 that traverse the roadway. The logic contract may specify a list of senders or consumers from which the reward of MapCoin will be acquired. In an example, a vehicle that is traversing the roadway makes use of an HD map service. The vehicle is further running a full MapCoin network node. As the vehicle traverses the roadway, a navigation device 122 integrated with the vehicle performs spatial queries on the MapCoin blockchain. As the MapCoin blockchain is stored in a spatial structure, the navigation device 122 may quickly identify upcoming ODPs. The navigation device 122 may identify upcoming previously validated ODPs and navigate the vehicle appropriately. In return for the information regarding the ODP, the navigation device 122 rewards both the originator and the validators of the ODP by adding an identifier for the navigation device 122 to the senders list in the storage contract.

As such, the vehicle is operating as a full MapCoin network node. As the vehicle travels over the ODP, thereby consuming the ODP, a spatial search of the entire MapCoin blockchain for any/all contracts is conducted with the geographic coordinates of the ODP being consumed. If a contract is found, as in the case here, the wallet address of this ODP consumer is appended to list of senders within the contract.

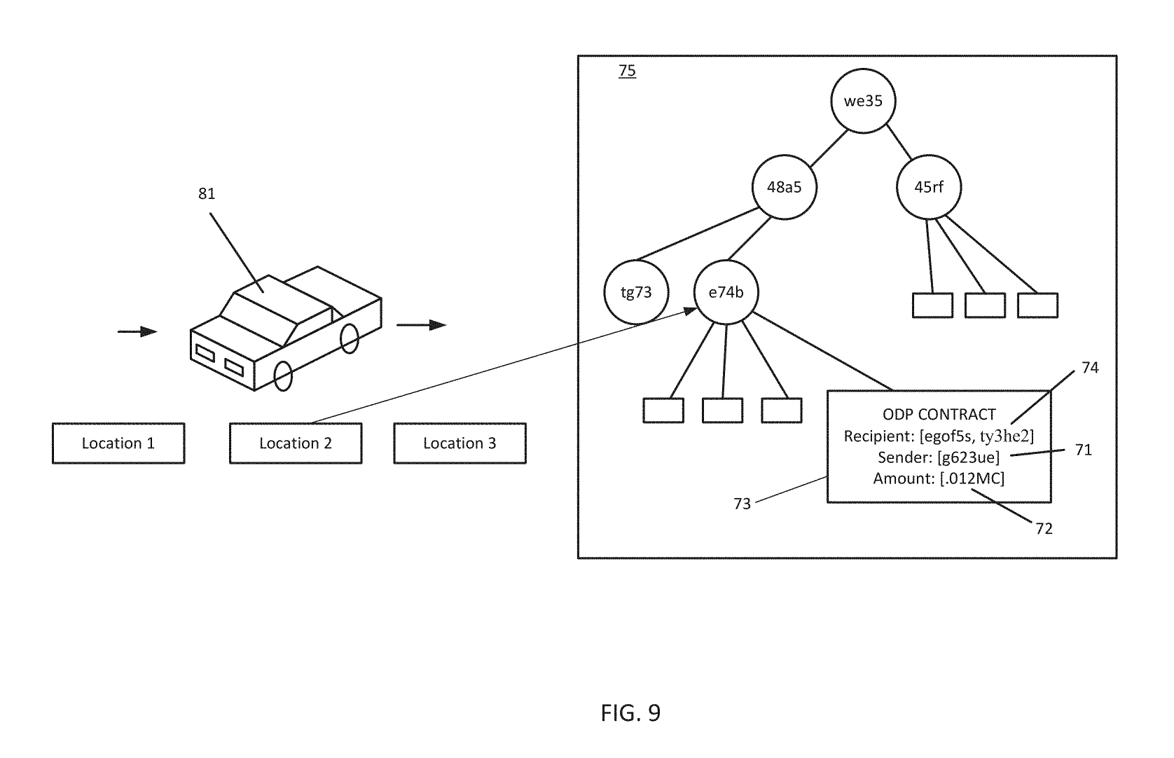

FIG. 9 depicts an example of contract consumption. Subsequent to the process of FIG. 7 and FIG. 8, a third vehicle 81 traverses the roadway and comes across location 2. The third vehicle queries the blockchain structure 75 to find new features on the roadway. Finding an existing validated ODP contract, the third vehicle downloads the ODP and adds its address (g623ue) to the sender's list 71 in the mutable storage contract. The ODP contract, once augmented may be transmitted to other devices 122/nodes in the blockchain to be verified and added to the blockchain. After the ODP contract is added to the blockchain, the contract may be executed, and the amount of MC is transferred. Depending on the logic of the ODP contract, the third vehicle may transfer the full amount 72 or a portion of the amount 72 to the addresses in the recipients list.

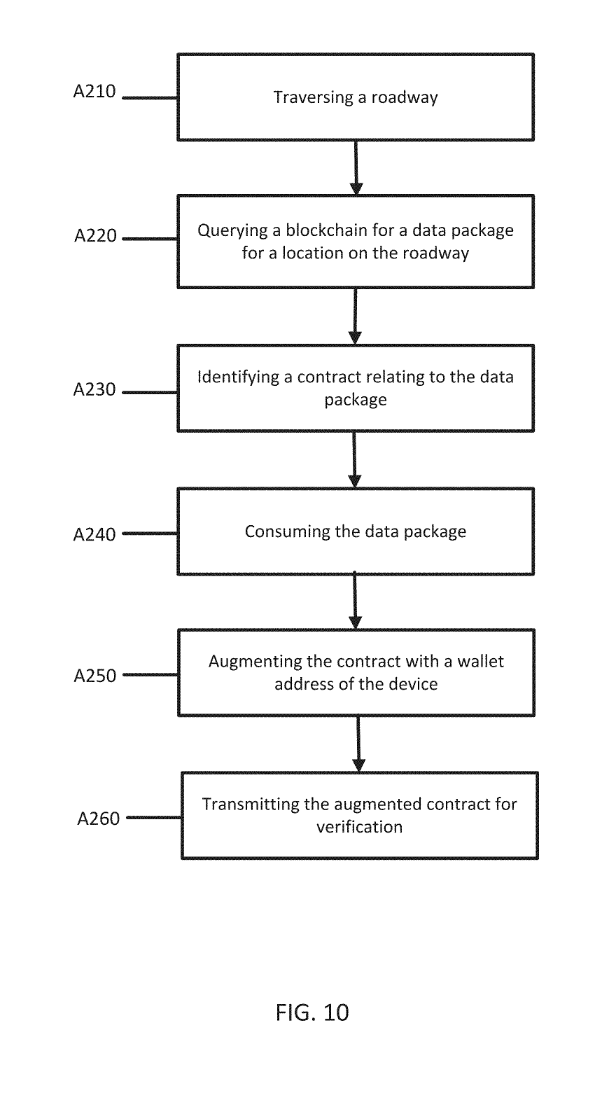

FIG. 10 illustrates an example flow chart for consuming HD map data. As presented in the following sections, the acts may be performed using any combination of the components indicated in FIG. 2 or FIG. 11. The following acts may be performed by the server 125, the device 122, the mapping platform 121, or a combination thereof. One or more nodes (devices 122) of the MapCoin blockchain may perform portions of the Acts. Additional, different, or fewer acts may be provided. The acts are performed in the order shown or other orders. The acts may also be repeated. Certain acts may be skipped.

At act A210, HD map data is used by a navigation device 122 as the navigation device 122 traverses a roadway network. The navigation device 122 may subscribe to a service that provides the HD map. As part of the service, the navigation device 122 may be rewarded for identifying new or changed features and may be charged for consuming (using) feature data that other devices 122 have identified.

At act A220, a MapCoin blockchain is queried for an entry relating to a location. The navigation device 122 may store a full or partial copy of the MapCoin blockchain. The MapCoin blockchain may include a plurality of blocks containing a plurality of contracts for observations generated by other devices 122 in the network. The blockchain may be organized spatially based on the location of the observations using a tree structures, such as a Merkle-Patricia tree.

At act A230, the navigation device 122 identifies a contract relating to an observation data package for the location in the blockchain. The contract may include data relating to an observation by a different device 122 or vehicle that specifies a change to the HD map that is used by the navigation device 122. For example, the contract may include data for a new sign at a location on the roadway. The contract may provide the observation data and logic for rewarding the original observer and any validators of the observation. The logic may specify an amount of digital currency to be transferred from consumers to the initial observer and validators. The logic portion of the contract may be immutable but may include one or more references to mutable (modifiable) storage contracts where a list of addresses for the recipients and consumers may be stored.

At act A240, the navigation device 122 consumes the observation data package. Consumption may include downloading the map data associated with the observation data package and adding the map data to a local HD map database.

At act A250, the navigation device 122 augments the contract with a wallet address of the navigation device 122. The contract may include a mutable storage contract that includes a list of senders from which an amount of digital currency is to be withdrawn.

At act A260, the navigation device 122 transmits the augmented contract to a plurality of nodes of the blockchain for verification and addition to the blockchain. For the transfer of digital currency to be performed, the augmentation to the storage contract must be verified and added to the blockchain. The augmented contract may be added to a block and verified by other devices 122/nodes in the blockchain network by a proof of work, proof of stake, or other proofing method. When the augmented contract is added to the blockchain, the amount of digital currency is transferred from the address of the navigation device 122 to one or more addresses listed in the contract. The one or more addresses may include both the originator and any subsequent vehicles or devices that have observed the same feature, for example that is missing from the HD map. The subsequent vehicle lend weight and corroborate the observation detected by the creator vehicle or device. The corroborated observations are aggregated into a canonical feature that is added to the HD map that is consumed by the navigation device 122.

FIG. 11 illustrates an example device 122 of the system of FIG. 2. The device 122 may be configured to collect, transmit, receive, process, or display data. The device 122 may also be referred to as a probe 122, a mobile device 122 or a navigation device 122. The device 122 includes a controller 201, a memory 209, an input device 203, a communication interface 205, position circuitry 207, and an output interface 211. Additional, different, or fewer components are possible for the mobile device 122. The device 122 may be smart phone, a mobile phone, a personal digital assistant (PDA), a tablet computer, a notebook computer, a personal navigation device (PND), a portable navigation device, and/or any other known or later developed mobile device. In an embodiment, a vehicle may be considered a device 122, or the device 122 may be integrated into a vehicle. The device 122 may receive or collect data from one or more sensors in or on the vehicle.

The controller 201 may include a general processor, digital signal processor, a graphics processing unit (GPU), an application specific integrated circuit (ASIC), field programmable gate array (FPGA), analog circuit, digital circuit, combinations thereof, or other now known or later developed processor. The controller 201 may be a single device or combinations of devices, such as associated with a network, distributed processing, parallel processing, or cloud computing, or combinations therein.

The communications interface 205 may include any operable connection. An operable connection may be one in which signals, physical communications, and/or logical communications may be sent and/or received. An operable connection may include a physical interface, an electrical interface, and/or a data interface. The communication interface 205 provides for wireless and/or wired communications in any now known or later developed format. The communication interface 205 may include a receiver/transmitter for digital radio signals or other broadcast mediums.

The memory 209 may be a volatile memory or a non-volatile memory. The memory 209 may include one or more of a read only memory (ROM), random access memory (RAM), a flash memory, an electronic erasable program read only memory (EEPROM), or other type of memory. The memory 209 may be removable from the mobile device 122, such as a secure digital (SD) memory card. The memory may contain a locally stored geographic database 123. The locally stored geographic database 123 may be a copy of the geographic database 123 or may include a smaller piece. The locally stored geographic database 123 may use the same formatting and scheme as the geographic database 123.

The memory 209 may store a full or partial copy of a blockchain. The device 122 may function as a node in a blockchain network. The controller 201 may be configured to query the blockchain stored memory 209 for map data relating to a location. The controller 201 may be configured to communicate with other devices 122 in the blockchain network using the communications interface 205. The controller 201 may be configured as a “miner” and may be configured to perform a proof of work process to validate blocks and transactions in the blockchain.

A device 122 may traverse a roadway network. The current location of the device 122 (and as such, vehicle) may be identified using positional circuitry 207 such as GPS or other positional inputs. The positioning circuitry 207, which is an example of a positioning system, is configured to determine a geographic position of the device 122. The positioning circuitry 207 may include movement circuitry, which is an example a movement tracking system, is configured to determine movement of a device 122. The position circuitry 207 and the movement circuitry may be separate systems, or segments of the same positioning or movement circuitry system. In an embodiment, components as described herein with respect to the navigation device 122 may be implemented as a static device. For example, such a device 122 may not include positional circuitry 207 but may involve a speed or velocity detecting input device. The device 122 may identify its position as the device 122 travels along a route using the positional circuitry. For indoor spaces without GPS signals, the navigation device 122 may rely on other geolocation methods such as LIDAR, radar, Wi-Fi, beacons, landmark identification, inertial navigation (dead reckoning), among others.

The device may be configured to request and/or generate a route from a first position to a destination. The device may use data in the geographic database to identify an efficient route from the first position to the destination. The device may use updates for the HD map including ODPs stored or recorded on the MapCoin blockchain to determine an efficient or desired route (according to user preferences). The device may use updates for the HD map to alter an existing route.

The device 122 may be configured to identify or observe features on the roadway and store the observations and location data related to therein. Via a smartphone application stored in the memory 209 and executed by the controller 201 in the device 122 and/or the software running on-board the vehicle itself, the observed features are encoded as an observation data package (ODP). The application performs a spatial query against the blockchain network to discover whether data entries currently exist for the ODP. This is accomplished via a spatial search of all transactions in every block of the blockchain. For the spatial search a Merkle-Patricia tree (trie) or another appropriate data structure is used that allows for efficient spatial queries of the transactions. The spatial query is efficient because the key under which the ODP value is stored is encoded as the “path” to be taken down the tree and is based on the geographic location of the ODP on the Earth. Finding no data entries for the ODP, minimally two smart contracts are then created and written to the blockchain. Smart contract code within transactions of blocks is immutable, storage for contracts however is not. Therefore, the first contract for the ODP is a logic contract that stores the core transaction logic to calculate the amount of MapCoin to be transferred from senders to recipients. The amount will be determined by many factors: Quality Index predictive modeling, age of the given ODP, and the number of other creators and validators of this ODP, if any. The logic contract for the ODP also stores the address of which contracts to call in the second, modifiable storage contract. The modifiable storage contract only accepts read and write calls from trusted addresses (the logic contract). It is in this storage contract that sender and recipient lists are created; on contract execution MapCoin will be transferred from senders to recipients in a single state transition in accordance with the logic contract. As logic and storage contracts are created, the wallet address of the creator of the ODP contract is appended to the recipient list. The new data entries are stored with the geographic location of the ODP itself within the Merkle-Patricia tree. The tree is then stored within a block waiting to be mined and thus validated and added to the blockchain.

Validation of the ODP is defined as when the ODP has already been created but continues to be re-driven and re-collected by subsequent devices 122. For the purposes of detecting change within the HD Map, ODP validation is equally as critical as ODP creation. For ODP validation, the terms and code of the logic contract transaction are immutable as mentioned above. Thus, ODP validation is a function of contract discovery to augment the storage contract immutably associated with the logic contract. Once again spatial queries are conducted against the Merkle-Patricia trees stored in each block to discover the contracts associated with the ODP. Once the contract transaction is discovered, the wallet address of the validator is appended to the recipients list, and the amount of MapCoin awarded to all recipients is adjusted accordingly.

ODPs are consumed via an application stored in memory 209 and executed by the controller 201. As such, the device 122 is operating as a full MapCoin network node. As the vehicle travels over the ODP, thereby consuming the ODP, a spatial search of the entire blockchain for any/all contracts is conducted with the geographic coordinates of the ODP being consumed. If a contract is found, as in the case here, the wallet address of the ODP consumer is appended to list of senders within the contract.

Mining MapCoin, as used here, does not deviate from the core definition of mining within other cryptocurrency networks. Mining may be defined as a separate process used to verify transactions in the blockchain ledger. Mining solves for the proof-of-work number, allows the block to be appended to the chain, and is conducted by any and all members of the network who choose to participate. Mining is computationally very expensive thus those who choose to offer their compute capacity, electricity and bandwidth are rewarded with fractions of coin. This incentivizes miners to participate, validate the network, and earn coin while simultaneously dis-incentivizing malicious actors from attempting to offer up multiple differing yet self-consistent ledgers. Mining thereby solves the double-spend problem and fends off Sybil attacks.

The contract transaction for the given ODP contract is executed at the point in time when the block is mined, e.g. when the transactions within the block have been validated and officially added to the blockchain. At this time, the transfer of MapCoin will occur from the senders to the recipients in accordance with the logic immutably encoded in the business logic contract for the ODP. Contract execution is re-run by every validating node upon receipt of the block. However, MapCoin is not continually transferred.

The device 122 may be configured to execute routing algorithms using a geographic database 123 to determine a route to travel along a road network from a starting location to a destination location in a geographic region. Using input from an end user, the device 122 examines potential routes between the origin location and the destination location to determine the optimum route in light of user preferences. The device 122 may then provide the end user with information about the route in the form of guidance that identifies the maneuvers required to be taken by the end user to travel from the origin to the destination location. Some devices 122 show detailed maps on displays outlining the route, the types of maneuvers to be taken at various locations along the route, locations of certain types of features, and so on. The device 122 may receive data from the geographic database 123 through the communications interface 205.

The input device 203 may be one or more buttons, keypad, keyboard, mouse, stylist pen, trackball, rocker switch, touch pad, voice recognition circuit, or other device or component for inputting data to the device 122. The input device 203 and the output interface 211 may be combined as a touch screen, that may be capacitive or resistive. The output interface 211 may be a liquid crystal display (LCD) panel, light emitting diode (LED) screen, thin film transistor screen, or another type of display. The output interface 211 may also include audio capabilities, or speakers.

The device 122 may be integrated into an autonomous vehicle or a highly-assisted or highly-automated driving (HAD) vehicle. The device 122 may be configured as a navigation system for an autonomous vehicle or a HAD. An autonomous vehicle or HAD may take route instruction based on the link and node information provided to the navigation device 122. An autonomous vehicle or HAD may be configured to observe and report features to a mapping platform 121. An autonomous vehicle or HAD may be configured to receive mapping data from a mapping platform 121 or geographic database 123.

The device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle. The assisted driving device may include memory, a processor, and systems to communicate with the mobile device 122. The assisted driving vehicles may response to geographic data received from geographic database 123 and the server 125, which may have been updated.

While traversing the roadway, the device 122 may identify one or more new or altered features by searching the blockchain. As described above, the device 122 may consume the data on the blockchain to improve the HD map stored in the device 122. For an autonomous vehicle, the data that is consumed from the blockchain may lead to a determination by the device 122 that the vehicle should take an action (e.g. brake, turn, alter sensors, slow down, speed up, etc.). The device 122 may generate a command for the vehicle as a function of the data on the blockchain. The command may result in an action by the vehicle.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in the specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

The following embodiments are disclosed. Embodiment 1: a decentralized system for incentivizing collection of map data comprising a plurality of devices for collecting map data, wherein each of the plurality of devices comprises: at least one sensor configured to acquire sensor data relating to a feature at a location on a roadway; a communication interface configured to communicate with at least one other device of the plurality of devices; and a device processor configured to generate an observation data package from the sensor data, perform, using the location, a spatial query on a blockchain configured to store a plurality of data entries to identify whether any data entries of the plurality of data entries exist for the observation data package; wherein when no data entries exist, the device processor is configured to generate a new data entry for the blockchain for the observation data package, and wherein when a data entry exists, the device processor is configured to validate the observation data package and augment the existing data entry.

Embodiment 2: The system of embodiment 1, wherein the device processor is further configured to add the new data entry or the augmented existing data entry to a block and transmit the block to the plurality of devices for verification and addition to the blockchain.

Embodiment 3: the system of embodiment 2, wherein the new data entry or the augmented existing data entry is executed when the block is added to the blockchain.

Embodiment 4: the system of embodiment 2, wherein the verification comprises a proof of work process.

Embodiment 5: the system of embodiment 3, wherein an amount of digital currency is rewarded to a device of the plurality of devices that first completes the proof of work process.

Embodiment 6: the system of embodiment 3, wherein an amount of digital currency is rewarded to an initial generator and each validator when the new data entry or the augmented existing data entry is executed.

Embodiment 7: the system of embodiment 1, wherein when no data entries exist, the device processor is configured to generate two new data entries on the blockchain for the observation data package.

Embodiment 8: the system of embodiment 7, wherein the two new data entries comprise an immutable logic contract and a modifiable storage data contract.

Embodiment 9: the system of embodiment 8, wherein the immutable logic contract comprises logic that defines a reward for a list of addresses and the modifiable storage data contract comprises storage for the list of identities of an originator and validators.

Embodiment 10: the system of embodiment 8, wherein when the data entry exists, the device processor is configured to validate the observation data package and augment the modifiable storage data contract with an address for the device processor.

Embodiment 11: the system of embodiment 1, wherein the observation data package comprises at least a description of the feature and location data for the feature on the roadway.

Embodiment 12: the system of embodiment 11, wherein the description of the feature on the roadway describes the absence of the feature on the roadway.

Embodiment 13: the system of embodiment 1, wherein the at least one sensor comprises a light detection and ranging based sensor.

Embodiment 14: the system of embodiment 1, wherein the blockchain stores a plurality of data entries organized spatially in a Merkle-Patricia tree data structure.

Embodiment 15: A method for incentivizing collection of map data by a navigation device, the method comprising: collecting, by the navigation device, observation data for a new feature on a roadway; generating, by the navigation device, an observation data package based on the observation data; querying, by the navigation device, a blockchain network for a data entry related to the feature data; generating, by the navigation device, a data entry when no existing data entry is found on the blockchain network, or validating, when found on the blockchain, by the navigation device, the existing data entry and augmenting the existing data entry with an address for the navigation device; and transmitting, by the navigation device, the new data entries or the augmented existing data entry to a plurality of nodes of the blockchain network to be added to a block of the blockchain network.

Embodiment 16: the method of embodiment 15, wherein the blockchain network stores a plurality of data entries organized spatially in a Merkle-Patricia tree data structure.

Embodiment 17: the method of embodiment 15, wherein the new data entry comprises an immutable logic data entry that specifies how an amount of digital currency and how the amount will be distributed upon execution of the immutable logic contract and a modifiable storage data entry that stores one or more wallet addresses.

Embodiment 18: a method for incentivizing collection of map data, the method comprising: traversing a location by a navigation device; querying, by the navigation device, a blockchain by location for a smart contract relating to the observation data package in the blockchain; accessing, by the navigation device, the observation data package; augmenting, by the navigation device, the smart contract with a wallet address of the navigation device; and transmitting, by the navigation device, the augmented smart contract to a plurality of nodes of the blockchain for verification and addition to the blockchain; wherein when the augmented smart contract is added to the blockchain, an amount of digital currency is transferred from the wallet address of the navigation device to one or more wallet addresses listed in the augmented smart contract.

Embodiment 19: the method of embodiment 18, wherein the blockchain network stores a plurality of smart contracts organized spatially in a Merkle-Patricia tree data structure.

Embodiment 20: the method of embodiment 18, wherein the smart contract comprises an immutable logic contract that specifies an amount of digital currency and how the amount of digital currency will be distributed and a modifiable storage contract that stores the wallet address of the navigation device and the one or more wallet addresses.

1. A decentralized system for incentivizing collection of map data comprising a plurality of devices for collecting map data, wherein each of the plurality of devices comprises:
at least one sensor configured to acquire sensor data relating to a feature at a location on a roadway;
a communications interface configured to communicate with at least one other device of the plurality of devices; and
a device processor configured to generate an observation data package from the sensor data, perform, using the location, a spatial query on a blockchain configured to store a plurality of data entries to identify whether any data entries of the plurality of data entries exist for the observation data package;
wherein when no data entries exist, the device processor is configured to generate a new data entry for the blockchain for the observation data package, and
wherein when a data entry exists, the device processor is configured to validate the observation data package and augment the existing data entry.

2. The system of claim 1, wherein the device processor is further configured to add the new data entry or the augmented existing data entry to a block and transmit the block to the plurality of devices for verification and addition to the blockchain.

3. The system of claim 2, wherein the verification comprises a proof of work process.

4. The system of claim 3, wherein an amount of digital currency is rewarded to a device of the plurality of devices that first completes the proof of work process.

5. The system of claim 2, wherein the new data entry or the augmented existing data entry is executed when the block is added to the blockchain.

6. The system of claim 5, wherein an amount of digital currency is rewarded to an initial generator and each validator when the new data entry or the augmented existing data entry is executed.

7. The system of claim 1, wherein when no data entries exist, the device processor is configured to generate two new data entries on the blockchain for the observation data package.

8. The system of claim 7, wherein the two new data entries comprise an immutable logic contract and a modifiable storage data contract.

9. The system of claim 8, wherein the immutable logic contract comprises logic that defines a reward for a list of addresses and the modifiable storage data contract comprises storage for the list of identities of an originator and validators.

10. The system of claim 8, wherein when the data entry exists, the device processor is configured to validate the observation data package and augment the modifiable storage data contract with an address for the device processor.

11. The system of claim 1, wherein the observation data package comprises at least a description of the feature and location data for the feature on the roadway.

12. The system of claim 11, wherein the description of the feature on the roadway describes the absence of the feature on the roadway.

13. The system of claim 1, wherein the at least one sensor comprises a light detection and ranging based sensor.

14. The system of claim 1, wherein the blockchain stores a plurality of data entries organized spatially in a Merkle-Patricia tree data structure.

15. A method for incentivizing collection of map data by a navigation device, the method comprising:
collecting, by the navigation device, observation data for a new feature on a roadway;
generating, by the navigation device, an observation data package based on the observation data;
querying, by the navigation device, a blockchain network for a data entry related to the feature data;
generating, by the navigation device, a data entry when no existing data entry is found on the blockchain network, or validating, when found on the blockchain, by the navigation device, the existing data entry and augmenting the existing data entry with an address for the navigation device; and
transmitting, by the navigation device, the new data entries or the augmented existing data entry to a plurality of nodes of the blockchain network to be added to a block of the blockchain network.

16. The method of claim 15, wherein the blockchain network stores a plurality of data entries organized spatially in a Merkle-Patricia tree data structure.

17. The method of claim 15, wherein the new data entry comprises an immutable logic data entry that specifies how an amount of digital currency and how the amount will be distributed upon execution of the immutable logic contract and a modifiable storage data entry that stores one or more wallet addresses.

18. A method for incentivizing collection of map data, the method comprising:
traversing a location by a navigation device;
querying, by the navigation device, a blockchain by location for a smart contract relating to the observation data package in the blockchain;
accessing, by the navigation device, the observation data package;
augmenting, by the navigation device, the smart contract with a wallet address of the navigation device; and
transmitting, by the navigation device, the augmented smart contract to a plurality of nodes of the blockchain for verification and addition to the blockchain;
wherein when the augmented smart contract is added to the blockchain, an amount of digital currency is transferred from the wallet address of the navigation device to one or more wallet addresses listed in the augmented smart contract.

19. The method of claim 18, wherein the blockchain network stores a plurality of smart contracts organized spatially in a Merkle-Patricia tree data structure.

20. The method of claim 18, wherein the smart contract comprises an immutable logic contract that specifies an amount of digital currency and how the amount of digital currency will be distributed and a modifiable storage contract that stores the wallet address of the navigation device and the one or more wallet addresses.
